(19) United States
(12) Patent Application Publication
(10) Pub. No.: US 2005/0112023 A1
(43) Pub. Date: May 26, 2005

(54) Flow assay device comprising dry reagent cake

(76) Inventor: Greg Liang, Rancho Cucamonga, CA (US)

Correspondence Address: Greg Liang, 7878 OXFORD PLACE, RANCHO CUCAMONGA, CA, 91730, US

(21) Appl. No.: 10/982,237

(22) Filed: Nov. 5, 2004

Related U.S. Application Data
(60) Provisional application No. 60/516,975, filed on Nov. 5, 2003.

(51) Int. Cl. G01N 21/00

(52) U.S. Cl. 422/58; 436/169

(57) ABSTRACT

The current invention provides an assay device for detecting an analyte in a sample solution comprising a first reagent chamber having a soluble reagent cake comprising a labeled reagent in fluid communication with an immobilized reagent section having an immobilized reagent, which is further in fluid communication with a fluid receiving section. The assay method using the device of the invention comprises applying a sample solution to the first reagent chamber, dissolving the reagent cake, and flowing the sample solution comprising the dissolved labeled reagent through the immobilized reagent section to the fluid receiving section of the device. The assay result is determined by reading a signal of the label of the labeled reagent at the immobilized reagent section or the fluid receiving section. The device preferably comprises a flow control mechanism between the first reagent chamber and the immobilized reagent section.

This application claims priority of U.S. provisional application No. 60/516,975 filed on Nov. 5, 2003.

### FIELD OF THE INVENTION

The present invention is related to novel assay reagent components, assay devices, and methods for diagnostic testing of sample solutions. In particular, it relates to flow assay devices comprising soluble freeze-dried reagent cakes.

### BACKGROUND OF THE INVENTION

An analyte binding reaction based flow assay device for the detection of an analyte in a sample solution comprises a labeled reagent, a liquid permeable solid matrix comprising an immobilized reagent section having an immobilized reagent, and a fluid receiving section. The labeled reagent is an analogue of the analyte or a binder of the analyte labeled with a detectable label. The immobilized reagent, either a binder of the analyte or an analogue of the analyte, is anchored on the surface of the solid matrix. The combination of the labeled reagent and the immobilized reagent is configured for a competitive assay reaction or a sandwich assay reaction, which results in an assay signal corresponding to the presence or quantity of the analyte in the sample solution. In one type of competitive assay, the labeled reagent is a labeled analogue of the analyte and the immobilized reagent is a binder for the anlayte and the labeled reagent. In another type of competitive assay, the labeled reagent is a labeled binder of the analyte and the immobilized reagent is an analogue of the analyte. In either type of competitive assay, the analyte and the analogue of the analyte competitively bind with the binder reagent, and the quantity of the labeled reagent bound to the immobilized reagent is reversely proportional to the quantity of the analyte in the sample solution. In a sandwich assay, the labeled reagent is a labeled binder to one binding site of the analyte molecule and the immobilized reagent is a binder to a different binding site of the analyte molecule. Therefore, in the presence of the analyte in the sample solution, both the labeled reagent and the immobilized reagent bind to the analyte, which result in a complex of the labeled reagent, the analyte, and the immobilized reagent at the immobilized assay reagent section. The quantity of the labeled reagent bound at the immobilized reagent section is proportionally to the quantity of the analyte in the sample solution.

Flow assay devices include flow-through assay devices and lateral flow assay devices depending on the physical relationship of the immobilized reagent section to the sample flow path of the device.

In a current flow-through type assay device, the immobilized reagent section is disposed in a flow path capable of allowing a sample solution and the labeled reagent of the device to flow through in a direction that is at an angle with a surface area of the immobilized reagent section. The assay method using a flow-through assay device comprises flowing a sample solution and the labeled reagent solution through the immobilized reagent matrix along the flow path of the device. U.S. Pat. No. 5,155,022 to Naqui, et al. describes a flow-through assay for the detection of anti-Borrelia burgdorferi antibodies in the serum of a patient. In the Naqui assay device a Borrelia Buigdorferi antigen is coated on a liquid permeable membrane. The serum sample solution to be tested is allowed to flow through the membrane at a direction that is substantially perpendicular to the surface of the membrane. Subsequently, a dye labeled second antibody solution capable of binding to bound Borrelia burgdorferi antibody on the membrane is allowed to flow through the membrane. The presence of anti-Borrelia burgdorferi antibodies is determined by detecting the dye labeled second antibody at the immobilized reagent area of the membrane.

In current flow-through assay devices, the labeled reagent and the immobilized reagent section of the device are typically provided separately. In some flow-through assay devices, the labeled reagent is provided in liquid form, which is unstable due to spoiling or degradation of organic compounds in the liquid. In some other flow-through assay devices the labeled reagent is provided in a dry form and is dissolved in a buffer solution before it is used in the assay. However, this complicates the device composition and the assay procedure, which increases the chance for error in assay results.

In a lateral flow assay, as taught in U.S. Pat. No. 5,591,645 to Rosenstein, the sample solution flows laterally through a porous strip comprising an immobilized reagent section by capillary attraction. Typically, a lateral flow assay device is a porous membrane strip comprises a sample addition section, a labeled reagent section having a movable dry labeled reagent, an immobilized reagent section, and a fluid receiving section. In a lateral flow assay by Rosenstein, by capillary attraction, the sample solution applied to the sample addition section first moves to the labeled reagent section, dissolves the labeled reagent, and the sample solution containing the labeled reagent flows though the immobilized reagent section to the fluid receiving section. The presence or quantity of the analyte in the sample solution is determined by detecting the presence or quantity of the labeled reagent at the immobilized reagent section.

One common problem in current lateral flow assays is inconsistent assay results due to uncontrolled reaction time between the sample solution and the labeled reagent and inconsistent mix volume of the sample solution and the labeled reagent. The pattern and velocity of the sample flow through the porous assay strip is dependent upon some physical characteristics of the porous material, such as the pore size, the thickness, and the surface hydrophilicity of the porous material, which often are inconsistent. Varied flow rate and un-even flow front result in variation in reaction time and the volume of the sample solution mixed with the labeled reagent. The labeled reagent in a current lateral flow assay device is disposed in the porous assay strip by absorption, which spreads to an inconsistent area of the immobilized reagent section, which constitutes another reason for inconsistent mixing of the sample solution and the labeled reagent. Another common problem in current lateral flow assays are of low sensitivity for some analytes due to lose of analytes from the sample solution to the porous absorbent material of the assay strip due to surface adsorption before the sample solution contacts the labeled reagent. Analytes that are easily adsorbed to fibrous materials include small molecular size hydrophobic analytes, such as a hydrophobic hapten, and large molecular size analytes having hydrophobic domains.

U.S. Pat. No. 5,183,740 to Ligler et al. teaches a different type of flow assay, continuous flow displacement immunoassay. The assay taught in Ligler et al. utilizes a micro reaction column having an immobilized antibody of the analyte and a fluorescence labeled analyte bound to the immobilized antibody as an assay reagent. The labeled analyte is capable of being displaced by the analyte in the sample solution when the latter comes in contact with the assay reagent. The assay method comprises passing a buffer solution, and subsequently passing the sample solution through the reaction column, and determining the assay result by reading the fluorescence label of the displaced labeled reagent in the flow-through solution.

The method of Ligler et al. has the advantage of a simple assay reagent and fast assay reaction. However, due to steric hindrance, labeled large molecule analytes bound to immobilized antibodies are usually non-displaceable by sample analytes. Thus the method is limited to the detection of small molecules only. For the same reason, the label of a continuous flow displacement assay must be a small molecule. Visually readable labels are typically large molecules or aggregated small molecule particulates and are unsuitable for use in continuous flow displacement assays. Therefore, a continuous flow displacement assay depends on an instrument for the detection of assay signal.

There is a need for the development of a simple instrument free assay device and method capable of accurately detecting both large and small molecule analytes. With the growing demand for point-of-collection (POC) assay devices and methods, a desirable assay method using such a device is independent of instruments.

### SUMMARY OF THE INVENTION

The flow assay device of the present invention for the detection of an analyte in a sample solution comprises a first reagent chamber, an immobilized reagent section, and a fluid receiving section. The first reagent chamber contains a soluble reagent cake comprising a labeled reagent, a labeled analogue or a binder of the analyte. The immobilized reagent section comprises an immobilized reagent, an immobilized binder or an analogue of the analyte. The combination of the labeled reagent of the reagent cake and the immobilized reagent of the immobilized reagent section is configured to comprise reagents for a competitive assay or a sandwich assay. The adjacent sections of the device are in fluid communication, thus a sample solution applied to the first reagent chamber is capable of dissolving the reagent cake, and the sample solution containing the labeled reagent of the reagent cake is capable of flowing from the first reagent chamber and the immobilized assay reagent section to the fluid receiving section.

The flow assay method using the device of the invention comprises applying a sample solution to the first reagent chamber, dissolving the reagent cake with the sample solution, and flowing the sample solution containing the labeled reagent through the immobilized reagent section to the fluid receiving section. The presence or quantity of the analyte in the sample solution is determined by detecting the label signal of the labeled reagent at the immobilized reagent section or the fluid receiving section. One preferred embodiment of the device of the invention comprises a sample flow control mechanism disposed between the reagent cake and the immobilized reagent section for controlling the mix volume of the sample solution with the labeled reagent and the reaction time between the sample solution and the labeled reagent.

The improvement of the flow assay method using the device of the invention includes more consistent assay results and higher assay sensitivity than flow assay methods using current flow assay devices. The device and assay method are suited in detecting both large and small molecule analytes and, in some embodiments, the assay results are visually readable.

### BRIEF DESCRIPTION OF DRAWINGS

FIG. 1 is a schematic representation of a flow assay device (100) wherein 110 represents a first reagent chamber having a reagent cake (111) comprising a labeled reagent (112), 120 represents an immobilized reagent section having an immobilized reagent (121), and 130 represents a fluid receiving section.

FIG. 2 is a perspective view of a first reagent chamber structure of the device of the invention.

FIG. 3 is a sectional view of the device of FIG. 2.

FIG. 4 is a perspective view of a first reagent chamber structure of the device of the invention having an enlarged first open end.

FIG. 5 is a sectional view of the fist reagent chamber structure of FIG. 4.

FIG. 6 is a perspective view of a structure comprising an immobilized reagent section and a fluid receiving section of the device of the invention.

FIG. 7 is a sectional view of the structure of FIG. 6.

FIG. 8 is a perspective view of a flow-through type assay device of the invention having a first reagent chamber in fluid communication with a flow-through type immobilized reagent section and a fluid receiving section.

FIG. 9 is a sectional view of the device of FIG. 8.

FIG. 10 is a perspective view of a lateral flow assay strip.

FIG. 11 is a perspective view of a lateral flow assay strip comprising a porous fluid reservoir section.

FIG. 12 is a perspective view of a lateral flow type assay device of the invention comprising a molded plastic housing comprising a first reagent chamber and a lateral flow assay strip.

FIG. 13 is a sectional view of the assay device of FIG. 12.

FIG. 14 is a perspective view of a lateral flow type assay device of the invention comprising a molded plastic housing comprising a tubular flow passage connecting a first reagent chamber and a lateral flow assay strip.

FIG. 15 is a sectional view of the assay device of FIG. 14.

### DETAILED DESCRIPTION OF THE INVENTION

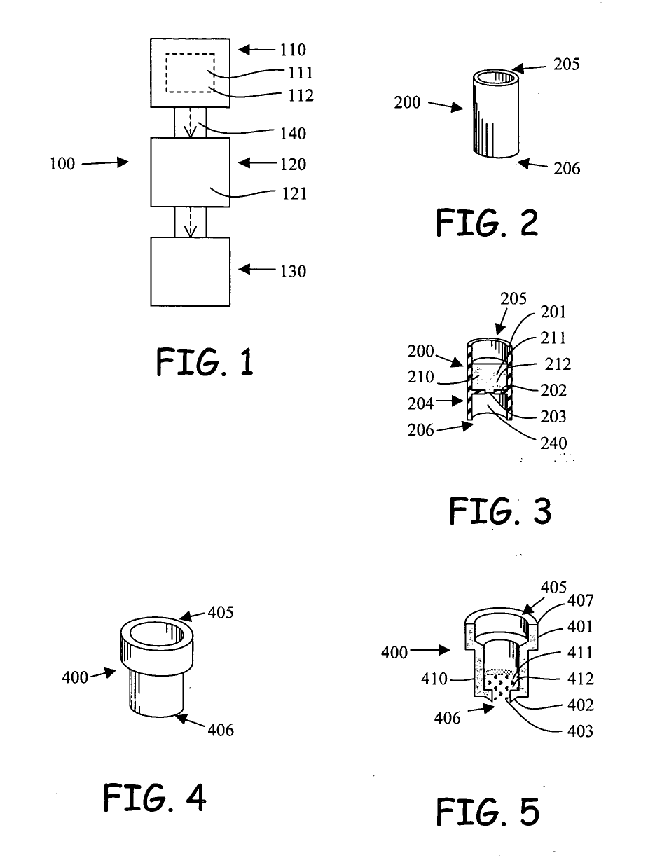

Referring to FIG. 1, the flow assay device (100) of the invention comprises a first reagent chamber (110) having a soluble reagent cake (111) comprising a labeled reagent (112), an immobilized reagent section (120) having an immobilized reagent (121), and a fluid receiving section (130), with the adjacent sections in fluid communication. A sample solution is capable of being introduced to the first reagent chamber (110), dissolving the reagent cake (111), and flowing through the immobilized reagent section (120) to the fluid receiving section (130). During the flow process, the analyte in the sample solution, the labeled reagent (112) of the reagent cake (111) and the immobilized reagent (121) of the immobilized reagent section (120) come in contact with each other, which initializes an assay reaction involving the analyte and the reagents. As a product of the assay reaction, a portion of the labeled reagent (112) is bound to the immobilized reagent section and the unbound labeled reagent is received at the fluid receiving section (130). In a given assay format, the quantity of the labeled reagent bound to the immobilized reagent (121) at the immobilized reagent section (120) or the fluid receiving section (130) is a function of the quantity of the analyte in the sample solution. Therefore, detecting the label signal of the labeled reagent at the immobilized reagent section (120) or the fluid receiving section (130) is capable of determining the presence or quantity of the analyte in the sample solution. An assay signal is a detectable signal of the label of the labeled reagent at the immobilized reagent section (120) or the fluid receiving section (130).

In a preferred embodiment of the invention, the flow assay device (100) comprises a sample flow control mechanism (140), disposed between the first reagent chamber (110) and the immobilized reagent section (120), which is capable of control of a sample flow from the first reagent chamber (110) to the immobilized reagent section (120). Sample flow control mechanisms include mechanisms capable of affecting the sample flow rate, flow pattern, and flow timing.

In one preferred embodiment of the invention, the device of the invention comprises a capillary orifice. In some embodiments, the capillary orifice is capable of limiting the sample flow rate from the first reagent chamber (110) to the immobilized reagent section (120). An additional function of a capillary orifice disposed at the second end of the first reaction chamber is holding a volume of liquid in the chamber from flowing through the orifice when the liquid flow motivating force is weaker than the capillary attraction force. For example, when 50 microliters (ul) of a sample solution is applied into a first reagent chamber comprising a circular orifice of 2 millimeter (mm) in diameter at the second open end of the chamber by holding the chamber in a vertical position with the first open end of the chamber being higher in altitude than the second end of the chamber, the sample solution is held within the chamber by capillary attraction. However, when an additional drop of sample solution is applied to the same chamber, a portion of the sample solution flows through the capillary orifice. Important applications of the liquid holding function of a capillary orifice of the first reaction chamber are disclosed in detail in other sections of this disclosure.

In accordance with another preferred embodiment of the invention, the flow assay device comprises a fluid reservoir connecting the first reagent chamber and the immobilized reagent section. The fluid reservoir prolongs the sample flow path from the first reagent chamber to the immobilized reagent section, in which the sample solution and the dissolved labeled reagent is further mixed by diffusion of the labeled reagent in the sample solution. In some assay embodiments, wherein the labeled reagent is a labeled binder of the analyte, a more complete reaction between the analyte of the sample solution and the labeled binder of the analyte is facilitated by mixing at the fluid reservoir section before the labeled reagent contacts the immobilized reagent, which improves the assay sensitivity. The fluid reservoir of the preferred embodiment of the invention is in the shape selected from a group consisting, among others, a cylinder, a cone, and a box.

In another preferred embodiment of the invention, the flow assay device comprises a capillary orifice connecting the first reagent chamber of the device and a broader fluid reservoir between the capillary orifice and the immobilized reagent section. One effect of a capillary orifice connecting the first reagent chamber to a broader fluid reservoir is to cause a turbulent flow at about the connection area of the capillary orifice and the downstream side fluid reservoir, which facilitates mixing of the sample front having high concentration of labeled reagent with the rest of the sample solution. Another effect of a capillary orifice and a downstream side broader fluid reservoir is holding the sample flow front from proceeding when the motivating force of the sample flow is weaker than the capillary attraction. The sample flow held by capillary attraction by the capillary orifice is capable of being reinitiated by increasing the flow motivating force. In some embodiments, prolonged reaction time of the analyte and the labeled reagent facilitates more complete assay reaction and improves the assay sensitivity. Therefore, in some embodiments, a capillary orifice and a downstream side broader fluid reservoir disposed between the first reagent chamber and the immobilized reagent section are capable of controlling the sample flow rate, flow pattern, and flow timing.

The first reagent chamber (110) of the device of the invention is a chamber having sidewalls and two open ends, a first open end and a second open end. A reagent cake (111) comprising a labeled reagent (112) is disposed inside the chamber between the two open ends. The first open end of the chamber provides access to a sample solution for the reagent cake (111) and the second open end of the chamber is capable of being in fluid connection with the immobilized reagent section (120) of the device. The sidewalls of the first reagent chamber (110) are made of an inert solid material selected from a group consisting plastic, rubber, and glass and is preferably made of a plastic material by plastic molding. The inner diameter (ID) of the chamber varies depending on the size or volume of the other components of the device and the volume of the sample solution to be tested. For the convenience of plastic molding and filling liquid reagent into the chamber, the ID of the chamber is preferably 1 millimeter (mm) to 10 mm, and is more preferably 3 mm to about 6 mm. The volume of the chamber is appropriate for holding the reagent cake and receiving the sample solution to be tested. In some embodiments of the invented device the first open end of the chamber is preferably an enlarged open end for easy access of liquids to the chamber and the second open end of the chamber is preferably a capillary orifice.

The reagent cake (111) is a soluble dry mass comprising a labeled reagent (112) and at least one cryoprotective agent. The reagent cake (111) of the device is preferably large enough to extend across the width of the tubular first reagent chamber (110), thus a sample solution applied to the first reagent chamber will consistently contact the entire reagent cake (111) before it flows from the first reagent chamber (110) to the immobilized reaction section (120). For accuracy of assay results, the reagent cake (111) is necessarily of a consistent shape and size and comprises an accurate amount of labeled reagent (112). The quantity of the labeled reagent (112) in each reagent cake (111) is calculated or experimentally optimized for achieving the desired assay sensitivity. The reagent cake (111) containing the desired amount of labeled reagent (112) is preferably prepared by diluting the labeled reagent (112) in a solution, dispensing the solution to desired volume aliquots and lyophilizing the dispensed aliquots. The solution for diluting the labeled reagent (112) for preparing the reagent cake (111) consists of at least one cryoprotective agent selected from a group consisting, among others, sucrose, mannitol, trehalose, dextran, ficoll, sodium cholate, bovine serum albumin, polyethylene glycol, and polyvinylpyrrolidone (PVP). At proper concentrations, preferably 0.5%-5% (w/v), the cryoprotective agent protects the activity of the labeled reagent (112), and forms a supporting lattice of the lyophilized cake (111). Detailed methods for using cryoprotective agents for preparing freeze-dried bioactive compounds have been taught elsewhere and are familiar to those skilled in the art. The reagent cake optionally comprises an insoluble fibrous material as an insoluble lattice of the reagent cake. The insoluble fibrous material is an inert fibrous material substantially non-adsorptive to the analyte to be detected. The inert fibrous material is selected from a group that consists of nylon, cellulose, and fiberglass. If the anlayte to be tested is highly hydrophobic and adsorptive to the surface of solid materials, the reagent cake is preferably free of insoluble materials.

One preferred lyophilized reagent cake is a lyophilized bead made by freeze-drying a frozen bead of the liquid blend comprising the labeled reagent. As in the method disclosed in U.S. Pat. No. 5,776,563 to Buhl et al, frozen beads of a liquid can be made by dripping measured droplets of the liquid reagent into a cryogenic liquid. The size of the dry bead is preferably appropriate for fitting into the first reagent chamber of the flow assay device without crunching the beads or being too small for forming a consistent labeled reagent-sample solution mixture when contacted by a sample solution applied to the first reagent chamber. More than one lyophilized bead can be disposed in the first reagent chamber. Multiple small beads usually have the same assay performance as a single bead of the mass equivalent to the total mass of the small beads. When bead reagents are employed in the assay device, a liquid permeable holding structure, such as a frit or a narrow orifice of the first reagent chamber is preferably disposed in the first reagent chamber of the device for holding the beads in the first reagent chamber.

In another preferred embodiment of the invention, the reagent cake (111) of the assay device is a molded reagent cake made by freeze-drying a volume of a liquid blend comprising the labeled reagent (112) into the first reagent chamber. The molded reagent cake properly situates inside the first reagent chamber (110). For the convenience of preparation of the molded reagent cake, the second end of the first reagent chamber preferably consists of a capillary orifice, thus that when a volume of the liquid blend containing the labeled reagent (112) is filled in the first reagent chamber (110), the liquid will be held inside the chamber by capillary attraction until it is freeze-dried into a dry cake. The concentration of the labeled reagent is preferably adjusted such that a desired amount of the labeled reagent is contained in 20-60 ul of liquid for lyophilization. Such a volume of liquid is easily dispensed into a first reagent chamber having a capillary orifice without having to plug any open ends of the first reagent chamber.

FIG. 2, in conjunction with FIG. 3, depicts an exemplary first reagent chamber structure (200) of a preferred embodiment of the invention. The tubular structure consists of a sidewall (201), a first open end (205) and a second open end (206), a septum (202) having a capillary orifice (203) separates the interior of the structure into a first reagent chamber (210) and a fitting structure (204) for fitting the structure to an immobilized reagent section structure. The first reagent chamber contains a reagent cake (211) comprising a labeled reagent (212).

FIG. 4, in conjunction with FIG. 5, depicts a first reagent chamber structure (400) of a different preferred embodiment of the device of the invention. The first reagent chamber structure (400) is a tubular plastic structure comprising a sidewall (401), a first open end (405), a second open end (406), and a first reagent chamber (410) containing a reagent cake (411) comprising a labeled reagent (412). The chamber (410) has an enlarged section (407) at the first open end (405). The wide first open end (405) provides easy access of the liquid reagent solution, precursor of the reagent cake (411), and the sample solution for testing. The narrow orifice framed by the narrowed section (402) at the second open end (406) holds the filled liquid reagent blend by capillary attraction when the liquid reagent blend is filled in the first reagent chamber and before it is lyophilized. The narrow orifice (403) is also capable of controlling the sample flow through the first reagent chamber (410).

The liquid permeable solid matrix of the immobilized reagent section of the assay device is selected from a group consisting porous membranes, such as fiberglass membrane, cellulose membrane, nylon membrane, cross-linked cellulose beads, cellulose fibers, glass-beads, and capillary tubes. The structure of the immobilized reagent section varies according to the material of the liquid permeable solid matrix as well as the type of the flow assay device.

The fluid receiving section of the assay device of the invention comprises a structure capable of receiving the sample solution from the immobilized reagent section, which consists of a chamber, a tube, a vial, or a liquid absorbent mass, such as a sponge, a paper pad, or a cotton ball.

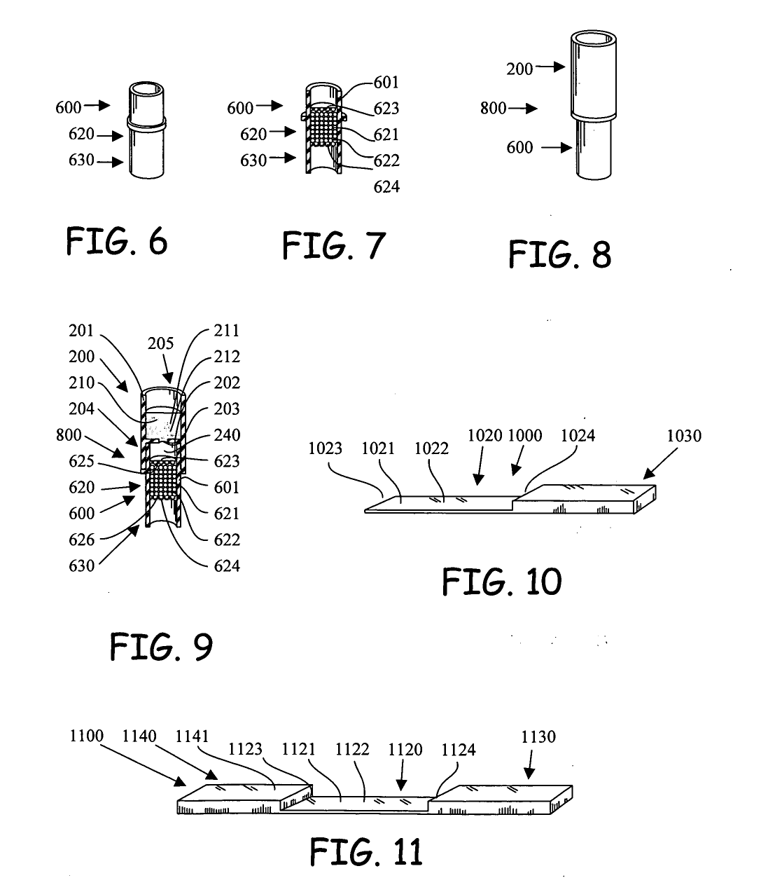

Referring to FIG. 6, in conjunction with FIG. 7, a preferred embodiment of the device of the invention comprises a flow-through type of immobilized reagent section (620) comprising a liquid permeable matrix (621) and an immobilized reagent (622). The immobilized reagent section (620) and a fluid receiving section (630) are preferably constructed in the same tubular plastic structure (600), wherein the sections are in fluid communication. The immobilized reagent section consists of two opposing ends, a first end (623) and a second end (624). The first end (623) of the section is capable of being in fluid communication with the second end of the first reagent chamber of the assay device and the section end (624) is in vluid communication with the fluid receiving section (630). The solid matrix (621) of the immobilized reagent section (620) preferably comprises a liquid permeable bead matrix held inside the tubular structure (600) by two liquid permeable frits (625 and 626) or a membrane.

Referring to FIG. 8, in conjunction with FIG. 9, a preferred embodiment of the device of the invention is a flow-through type assay device (800) comprising a first reagent chamber (210) containing a soluble reagent cake (211) comprising a labeled reagent (212) in fluid communication with a flow-through immobilized reagent section (620) comprising an immobilized reagent (622), which is further in fluid communication with a fluid receiving section (630). As depicted in FIG. 2, in conjunction with FIG. 3, the first reagent chamber (210) preferably comprises a capillary orifice (203) at its second end (206). A sample flow through the reagent sections of a flow-through type assay device of the invention is motivated by capillary attraction and gravity of the sample solution or by mechanical pressurization.

In a preferred embodiment of the invention, the assay device is a flow-through type assay device capable of permitting a sample flow from the first reagent chamber through the immobilized section to the fluid receiving section motivated by gravity or capillary attraction.

In yet another preferred embodiment of the invention, the flow-through type assay device capable of permitting a sample flow from the first reagent chamber through the immobilized section to the fluid receiving section motivated by gravity or capillary attraction comprises a labeled reagent labeled with a visual readable label. The entire assay process using such a device is independent of instruments, which is ideally suited in POC testing applications.

In another preferred embodiment of the invention, the flow-through type assay device of the invention comprises a mechanical mechanism for controlling the sample flow. The mechanical mechanism is selected from a group of mechanical mechanisms capable of controlling the sample flow from the first reagent chamber through the immobilized reagent section to the fluid receiving section, which includes a liquid pumping system, a flow valve, and a centrifugation system. The flow control mechanism is capable of controlling the sample flow rate and timing of the sample flow. For example, in some embodiments, a mechanical flow control mechanism is capable of switching on and off the sample flow, as it is desired.

Referring to FIG. 10, in another important preferred embodiment of the invention, the immobilized reagent section (1020) of the flow assay device comprises a lateral flow type assay component, wherein the solid matrix of the immobilized reagent comprises substantially a flat surface area (1021) capable of immobilizing sufficient reagent (1022) for an assay and permeating a sample solution laterally flow through. The flat surface area (1021) of the immobilized reagent section (1020) is consisted of a flat liquid permeable materials capable of immobilizing the assay reagent, which is selected from a group including porous membranes, such as nitrocellulose membrane, nylon membrane, acetic cellulose membrane, and fiberglass membrane, and a thin channel formed by disposing two solid surfaces at a capillary distance. Using membrane matrices for immobilizing assay reagents has been disclosed in U.S. Pat. No. 4,703,017 to Campbell et al. and elsewhere, and is familiar to those skilled in the art. Using a thin channel formed by disposing two solid surfaces at a capillary distance as the matrix in a lateral flow immunoassay has been taught in U.S. Pat. No. 6,767,510 to Buechler. Lateral flow of a sample solution through flat membrane surfaces or flat channels between surfaces at capillary distance is typically motivated by capillary attraction. The sample flow rate through a membrane is related to the membrane thickness, pore size, and surface properties. Preferably, the membrane of the immobilized reagent section (1020) of the device has a thickness about 100 microns to about 200 microns. The sample flow rate through the membrane is typically about 10 mm to 40 mm per minute. Treatment of the membrane with salts or surfactants usually increases the sample flow rate through the membranes.

The fluid receiving section (1030) of the lateral flow type assay device (1000) of the invention comprises a structure capable of receiving the sample solution from the immobilized reagent section (1020), which consists of a chamber, a tube, a vial, or a liquid absorbent mass, such as a sponge, a paper pad, or a cotton ball.

In a preferred embodiment of the invention, the flow assay device comprises a membrane immobilized reagent section (1020) and an absorbent fluid receiving section (1030). The sample flow in the assay process using the preferred assay device is capable of being motivated by gravity of the sample solution and capillary attraction and is capable of being instrument independent.

In another preferred embodiment of the invention, the flow assay device comprises a labeled reagent comprising a visible colored particulate label, a membrane immobilized reagent section (1020), and an absorbent fluid receiving section (1030). The sample flow of the assay process is capable of being motivated by gravity of the sample solution and capillary attraction. The assay result is capable of being visually read. Therefore, the entire assay process using the preferred assay device of the invention is capable of being independent of instruments. Such a flow assay device and the instrument-free assay method are ideally suited in POC testing applications.

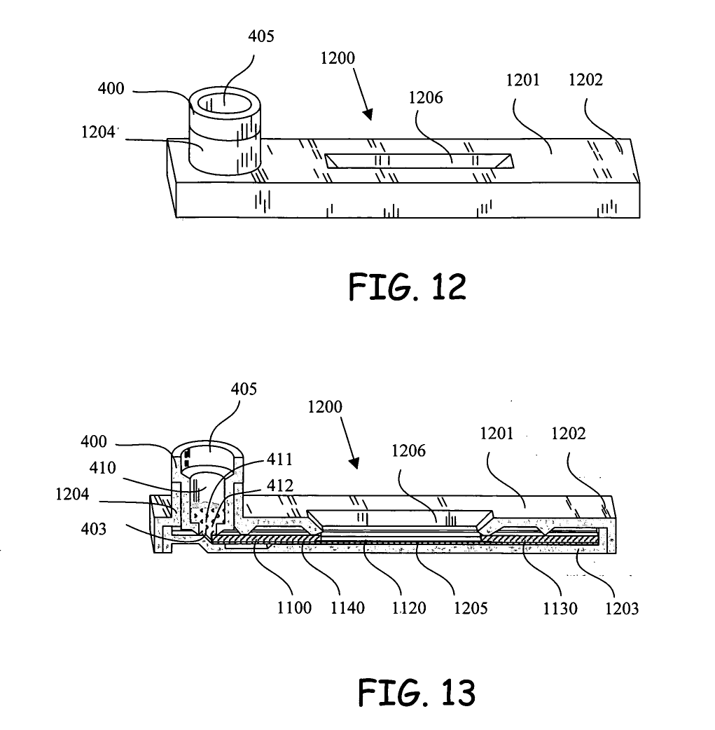

Referring to FIG. 11, in conjunction with FIG. 12, in another preferred embodiment of the invention, a lateral flow assay device comprising a membrane-immobilized reaction section (1120) and a porous fluid reservoir section (1140) disposed between the reagent cake of the first reagent chamber and the immobilized reagent section (1120). The porous fluid reservoir section (1140) comprises a porous mass (1141) that is capable of receiving a sample solution from the first reagent chamber by capillary attraction and releasing the sample solution to the immobilized reagent section (1120). The material of the porous fluid reservoir section (1140) is selected from a group of porous materials consisting sponge, fiberglass, cellulose membrane, and filter paper. The porous material of the porous fluid reservoir section (1140) is preferably of the same thickness as or thicker than the membrane of the immobilized reagent section and preferably has the same or larger pore size than the membrane of the immobilized reagent section. The sample solution received at the porous fluid reservoir section (1141) is slowly released to the immobilized reagent section (1120), therefore, overflow of the sample solution at the immobilized reagent section (1120) is prevented, which is a major benefit of having a porous fluid reservoir section (1140) between the first reagent and the immobilized reagent section (1120). Another benefit of having the porous fluid reservoir (1140) is it facilitates mixing of the sample solution and the labeled reagent by allowing the labeled reagent to diffuse in the porous fluid reservoir. The porous fluid reservoir section (1140) also contributes to the control of the sample flow rate by slowly releasing the sample solution to the immobilized reagent section (1120).

Referring to FIG. 12, in conjunction with FIG. 4, FIG. 5, FIG. 11, and FIG. 13, in one preferred embodiment of the invention, the flow assay device (1200) comprises a plastic housing (1201) enclosed by an upper molded piece (1202) and a lower molded piece (1203). The plastic housing (1201) comprises a first reagent chamber fixture (1204), a lateral flow assay strip fixture (1205), and a result view window (1206). A first reagent chamber structure (400) having a first reagent chamber (410) containing a reagent cake (411) comprising a labeled reagent (412) is snuggly fit to the device housing (1201) at the first reagent chamber fixture (1204). A lateral flow assay strip (1100) comprising an immobilized reagent section (1120) having an immobilized reagent (1121), a fluid receiving section (1130), and an optional porous fluid reservoir section (1140) is disposed at the fixture (1205) for the lateral flow assay strip. A sample solution is capable of being applied to the first reagent chamber (410), dissolving the reagent cake (411), and the sample solution containing the labeled reagent (412) of the reagent cake (411) is capable of flowing through the immobilized reagent section (1120) to the fluid receiving section (1130). An assay signal is capable of being detected at the immobilized reagent section (1120) of the assay strip (1100) through the result view window (1206). The first reagent chamber (410) is connected to the optional porous fluid reservoir section (1140) of the membrane assay strip (1100) through a capillary orifice (403) of the first reagent chamber (410). A sample solution containing the labeled reagent (412) must flow through the porous fluid reservoir section (1140) before it arrives the immobilized reagent section (1120), thus overflow of the sample solution at the immobilized reagent section (1120) is prevented.

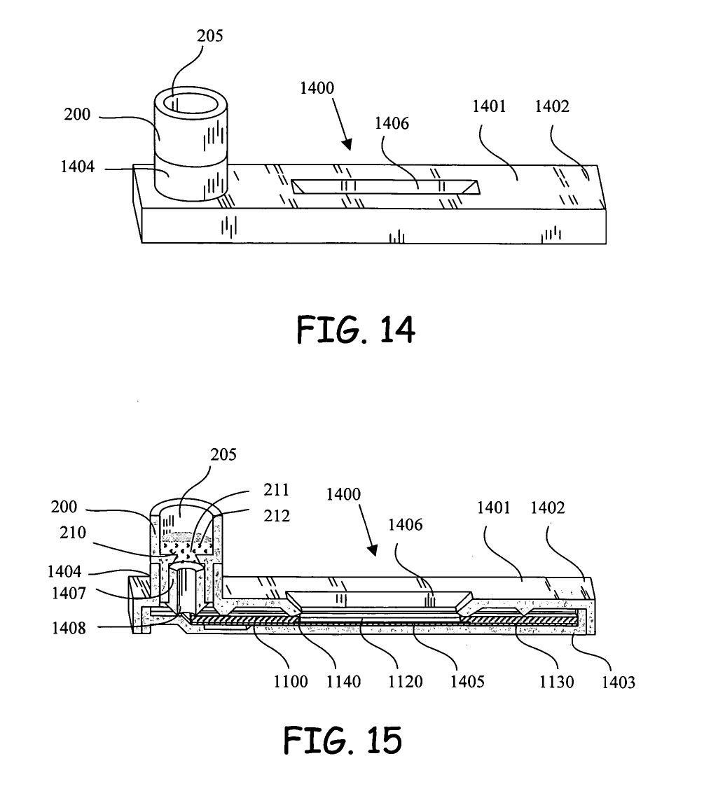

Referring to FIG. 14, in conjunction with FIG. 2, FIG. 3, FIG. 11, and FIG. 15, in another preferred embodiment of the invention, the assay device (1400) comprises a plastic housing (1401) enclosed by an upper molded piece (1402) and a lower molded piece (1403). The plastic housing (1401) comprises a first reagent chamber fixture (1404), a lateral flow assay strip fixture (1405), and a result view window (1406). A first reagent chamber structure (200) having a first reagent chamber (210) is snuggly fit to the first reagent chamber fixture (1404). A lateral flow assay strip (1100) comprising an immobilized reagent section (1120) is disposed at the fixture (1405) for the lateral flow assay strip. A sample solution is capable of being applied to the first reagent chamber (210), dissolving the reagent cake (211), and the sample solution containing the labeled reagent (212) of the reagent cake (211) is capable of flowing through the immobilized reagent section (1120) to the fluid receiving section (1130). An assay signal is capable of being detected at the immobilized reagent section (1120) of the assay strip (1100) through the result view window (1406). The first reagent chamber (210) is connected to a flow passage (1407) within a tube (1408) that is connected to the optional porous fluid reservoir section (1140) of the membrane assay strip (1100) through the orifice (203) of the first reagent chamber (210). A sample solution containing the labeled reagent (212) must flow through the flow passage (1407) and the porous fluid reservoir section (1140) before it arrives the immobilized reagent section (1120). Both the flow passage (1407) and the porous fluid reservoir section (1140) facilitates mixing of the sample solution and the labeled reagent (212) by diffusion of the labeled reagent in the sample solution, therefore, the labeled reagent (212) is capable of contacting the analyte in a larger portion of the sample solution before it flows through the immobilized reagent section (1120).

1. A flow assay device for the detection of an analyte in a sample solution comprising
1) a first reagent chamber having sidewalls, a first open end, and a second open end, containing a soluble reagent cake comprising a labeled reagent,
2) an immobilized reagent section comprising two opposing ends, a first end and a second end, an immobilized reagent, and
3) a fluid receiving section,
with the reagent cake of the first reagent chamber being accessible to a sample solution through the first open end of the first reagent chamber, the second end of the first reagent chamber being in fluid connection with the first end of the immobilized reagent section, and the second end of the immobilized reagent section being in fluid communication with the fluid receiving section, thus the sample solution is capable of being applied through the first open end of the first reagent chamber to the first reagent chamber, dissolving the reagent cake, and the sample solution comprising the labeled reagent of the reagent cake is capable of flowing through the immobilized reagent section to the fluid receiving section, and producing an assay signal at the immobilized reagent section or the fluid receiving section.

2. The device of claim 1, wherein the second open end of the first reagent chamber comprises a capillary orifice.

3. The device of claim 1, wherein the reagent cake comprises a bead reagent cake.

4. The device of claim 1, wherein the reagent cake is a molded cake prepared by freeze-drying a volume of liquid blend comprising the labeled reagent dispensed into the first reagent chamber.

5. The device of claim 2, wherein the reagent cake is a molded cake prepared by freeze-drying a volume of liquid blend comprising the labeled reagent dispensed into the first reagent chamber with the open ends of the first reagent chamber not being plugged.

6. The device of claim 1, wherein the immobilized reagent section comprises a reagent immobilized on a flow-through type solid matrix.

7. The device of claim 1, wherein the immobilized reagent section comprises a reagent immobilized on a lateral flow type solid matrix.

8. A flow assay device for the detection of an analyte in a sample solution comprising
1) a first reagent chamber having sidewalls, a first open end, and a second open end, containing a soluble reagent cake comprising a labeled reagent,
2) a sample flow control mechanism,
3)) an immobilized reagent section comprising two opposing ends, a first end and a second end, an immobilized reagent, and
4) a fluid receiving section,
with the reagent cake of the first reagent chamber being accessible to a sample solution through the first open end of the first reagent chamber, the second end of the first reagent chamber being in fluid connection with the first end of the immobilized reagent section, and the second end of the immobilized reagent section being in fluid communication with the fluid receiving section, thus the sample solution is capable of being applied through the first open end of the first reagent chamber to the first reagent chamber, dissolving the reagent cake, and the sample solution comprising the labeled reagent of the reagent cake is capable of flowing through the immobilized reagent section to the fluid receiving section, and producing an assay signal at the immobilized reagent section or the fluid receiving section.

9. The device of claim 8, wherein the second open end of the first reagent chamber comprises a capillary orifice.

10. The device of claim 8, wherein the reagent cake comprises a bead reagent cake.

11. The device of claim 8, wherein the reagent cake is a molded cake prepared by freeze-drying a volume of liquid blend comprising the labeled reagent dispensed into the first reagent chamber.

12. The device of claim 8, wherein the reagent cake is a molded cake prepared by freeze-drying a volume of liquid blend comprising the labeled reagent dispensed into the first reagent chamber with the open ends of the first reagent chamber not being plugged.

13. The device of claim 8, wherein the immobilized reagent section comprises a reagent immobilized on a flow-through type solid matrix.

14. The device of claim 8, wherein the immobilized reagent section comprises a reagent immobilized on a lateral flow type solid matrix.

15. The device of claim 8, wherein the sample flow control mechanism comprises a fluid reservoir connecting the first reagent chamber and the immobilized reagent section.

16. The device of claim 8, wherein the sample flow control mechanism comprises a capillary orifice and a downstream side broader fluid reservoir connecting the first reagent chamber and the immobilized reagent section.

17. The device of claim 16, wherein the fluid reservoir is a porous fluid reservoir comprising a porous absorbent mass.

18. The device of claim 13, wherein the sample flow control mechanism comprises a mechanical system selected from a group consisting a fluid pumping system, a flow valve, and a centrifugation system.

19. The device of claim 8, wherein the label of the labeled reagent is a visible substance.

20. A method for the detection of an analyte in a sample solution comprising
1) providing a device comprising
a) a first reagent chamber having sidewalls, a first open end, and a second open end, containing a soluble reagent cake comprising a labeled reagent,
b) an immobilized reagent section comprising two opposing ends, a first end and a second end, an immobilized reagent, and
c) a fluid receiving section,
with the reagent cake of the first reagent chamber being accessible to a sample solution through the first open end of the first reagent chamber, the second end of the first reagent chamber being in fluid connection with the first end of the immobilized reagent section, and the second end of the immobilized reagent section being in fluid communication with the fluid receiving section, thus the sample solution is capable of being applied through the first open end of the first reagent chamber to the first reagent chamber, dissolving the reagent cake, and the sample solution comprising the labeled reagent of the reagent cake is capable of flowing through the immobilized reagent section to the fluid receiving section, and producing an assay signal at the immobilized reagent section or the fluid receiving section,
2) applying the sample solution through the first open end of the first reagent chamber to the first reagent chamber of the device, dissolving the reagent cake of the first reagent chamber, flowing the sample solution comprising the labeled reagent of the reagent cake through the immobilized reagent section to the fluid receiving section, and
3) determining the presence or quantity of the analyte in the sample solution by detecting the label signal of the labeled reagent at the immobilized reagent section or the fluid receiving section.
